(19) United States
(12) Patent Application Publication
(10) Pub. No.: US 2009/0292612 A1
(43) Pub. Date: Nov. 26, 2009

(54) SYSTEM AND METHOD FOR DELIVERING ADVERTISING ACCORDING TO SIMILARITIES WITH COLLECTED MEDIA CONTENT

(75) Inventors: Bartel M. Van de Sluis, Eindhoven (NL); Elmo M.A. Diederiks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,458

(22) PCT Filed: Dec. 13, 2005
(86) PCT No.: PCT/IB2005/054214

§ 371 Date: Jun. 12, 2007

Related U.S. Application Data
(60) Provisional application No. 60/635,683, filed on Dec. 13, 2004.

(51) Int. Cl. G06Q 30/00

(52) U.S. Cl. 705/14.53

(57) ABSTRACT

A system and method for delivering advertising (100) to a user is disclosed. Values for characteristic properties of advertisements and stored media content items are determined (201, 203). A comparison is made between the characteristic values of the advertisements and the stored media content items (205). An advertisement is selected for delivery to the user according to the comparison (207). Individual advertisements and media content items may be compared across some or all characteristics (301), or individual advertisements may be compared to all the media content items for individual characteristics (401). Key characteristics may be identified for which the stored media content items exhibit a strong commonality (500), and comparisons made for only those key characteristics. A Λ virtual' media content item may be created (603), with characteristic values representative of the stored media content items, and advertisements compared to that Λ virtual' media content item (605).

The present invention is directed to a system and method for delivering advertising, and more specifically, to a system and method for delivering advertising in a media delivery device having access to a collection of media content items and a collection of advertisements.

Media content consumers are making increasing use of media delivery devices having the capability to store a collection of media content items. Such devices may be portable (for example MP3 players or personal digital assistants (PDAs)) or stationary (such as personal computers or television set-top boxes having digital video recorders). Where such media delivery devices also have networking capabilities, they may also receive advertisements for presentation to the user of the device.

Many such advertisements are aimed at the general public and may not be of interest to the user. As a result, such advertisements may be ineffective in attracting the user's interest to the advertised product or service.

Previous advertising delivery systems have attempted to solve this problem by selecting advertisements for display to a user according to a stored profile of the user's preferences. Such profiles are typically generated in one of two ways. In one type of system, the user is asked to submit to an ‘interview’ by the system: selections of items are offered to the user and the user's choices from among the selections are analyzed to create the user profile. This approach requires that the user invest the time required to train the advertising system—a process that the user may perceive as a waste of time.

In another type of system, the advertising system records the identities of selections the user makes among broadcast media (for example television programs) and constructs the user profile from the recorded data. Such a system will require a period of observation of a user before being able to offer well-targeted advertisements. The user profile will also lag behind any changes in interests that are later reflected in the user's programming selections.

Thus, there is a need in the art for a system and method of delivering advertisements to media content consumers where the advertisements are better and more quickly targeted to the interests of the consumers.

The present invention generally comprises a system and method for selecting advertisements for delivery according to similarities between the advertisements and stored media content on the user's media delivery device.

In an advantageous embodiment of the present invention, a device for delivering media content and advertising to a user has storage for a collection of media content items and an interface for connection to an advertising server. The device also has an advertising selector that compares several characteristics of the media content items and the advertisements in the server. The selector then chooses an advertisement to deliver to the user based upon the results of the comparison.

It is a primary object of the present invention to deliver advertisements to a media content consumer that are targeted to the interests of the consumer.

It is another object of the present invention to provide a media content and advertising delivery device that compares individual advertisements to individual stored media content items and selects an advertisement for delivery to the user based upon the comparisons.

It is an additional object of the present invention to provide a delivery device that selects an advertisement for delivery based upon a comparison of each advertisement to the collection of media content items as a group, for each of several characteristics.

It is yet another object of the present invention to provide a delivery device that creates a ‘virtual’ media content item, having values for a plurality of characteristics representative of the values for those characteristics of the stored collection of media content items. The device then compares each advertisement to the ‘virtual’ media content item and selects an advertisement for delivery to the user based upon the comparisons.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking a detailed description of the invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

For a more complete understanding of the present invention, and the advantages thereof, reference is now made to the following descriptions taken in conjunction with the accompanying drawings, wherein like numbers designate like objects, and in which:

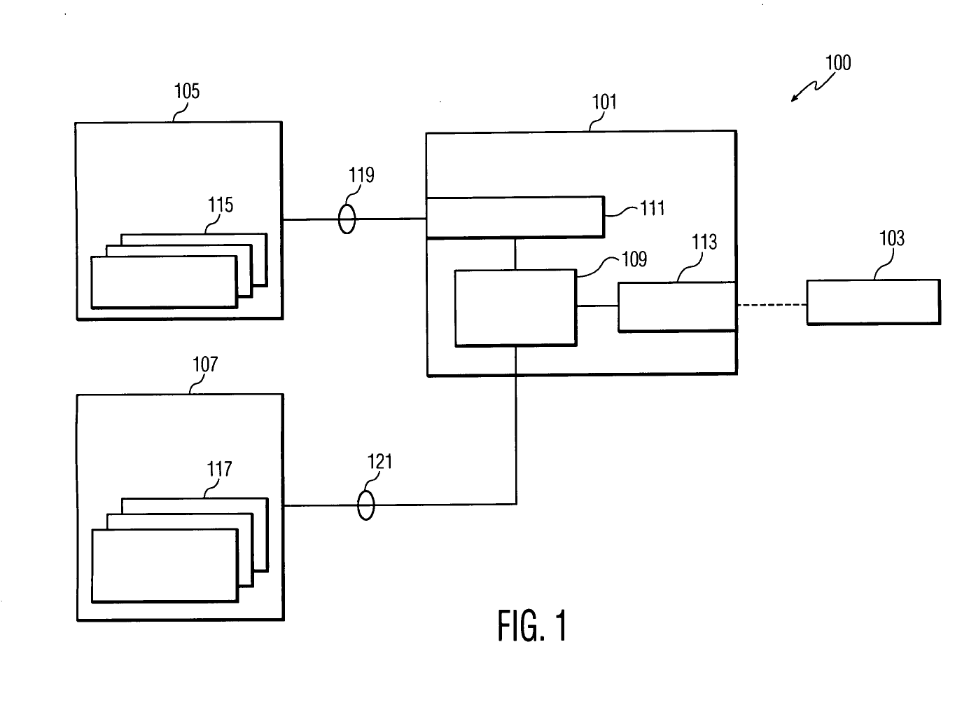

FIG. 1 illustrates a block diagram of an exemplary system for delivering advertising to a user;

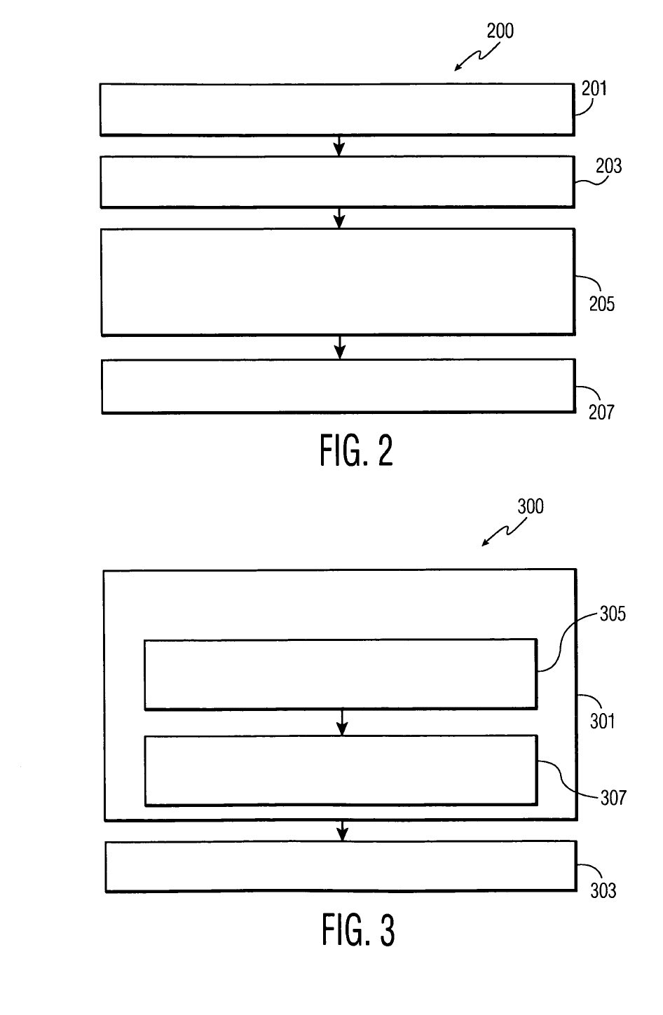

FIG. 2 is a flow diagram illustrating the operation of selecting and delivering an advertisement to the user according to one embodiment of the invention;

FIG. 3 is a flow diagram illustrating the operation of selecting an advertisement to the user according to an exemplary embodiment of the invention;

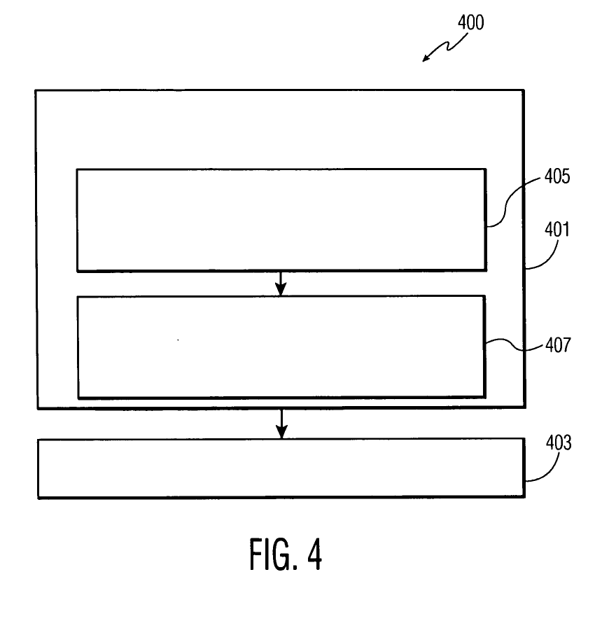

FIG. 4 is a flow diagram illustrating the operation of selecting an advertisement to the user according to another embodiment of the invention;

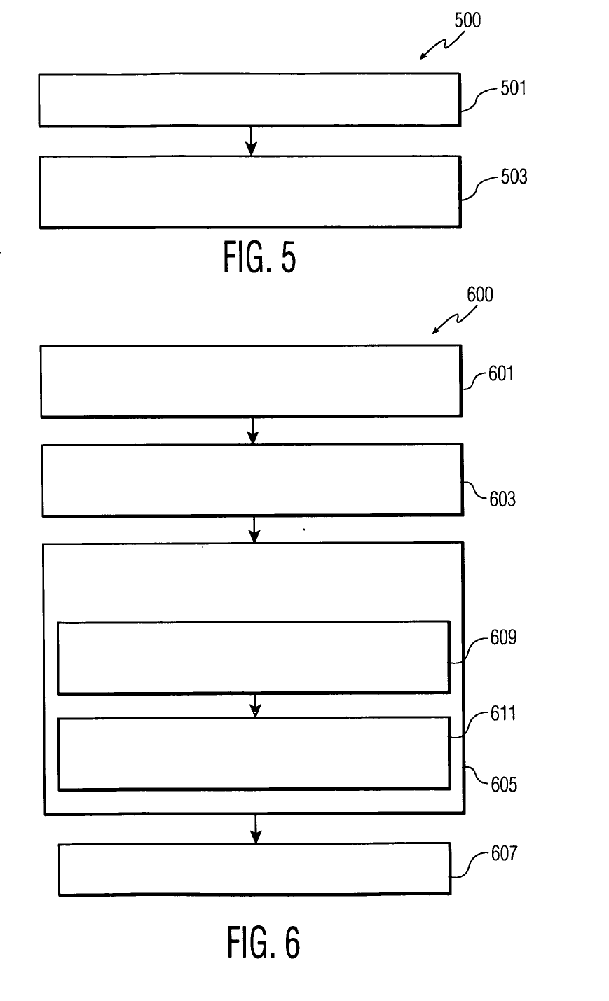

FIG. 5 is a flow diagram illustrating the operation of selecting an advertisement to the user according to yet another embodiment of the invention; and

FIG. 6 is a flow diagram illustrating the operation of selecting an advertisement to the user according to an embodiment of the invention.

FIGS. 1 through 6, discussed below, and the various embodiments set forth in this patent document to describe the principles of the system and method of the present invention are by way of illustration only and should not be construed in any way to limit the scope of the invention. Those skilled in the art will readily understand that the principles of the present invention may also be successfully applied in any suitably arranged advertising delivery system.

FIG. 1 illustrates a block diagram of an exemplary advertising delivery system 100. Delivery system 100 may comprise media content and advertising delivery device 101, coupled to advertising server 105 and media content storage device 107. Delivery device 101 may comprise processor 109 coupled to interface 111 and rendering device 113. The processor 109 is operable to communicate with the advertising server 105 via the interface 111 and connection 119. The processor 109 is also operable to communicate with the media content storage device 107 via connection 121.

User 103 of the delivery system 100 may perceive the advertisements as rendered by the rendering device 113. Where the advertisements are visual, the rendering device may be a display device. Where the advertisements are aural, the rendering device may be a speaker or earphones. Where the advertisements are audio-visual, the rendering device may be a combination of display device and speaker or earphones.

The exemplary advertising server 105 is operable to store a collection of advertisements 115. The media content storage device 107 is operable to store a collection of media content items 117. The user 103 may perceive media content items 117 as rendered by the rendering device 113 or as rendered by an alternative rendering device (not shown).

In one embodiment of the invention, the delivery device 101 may be a personal digital assistant (PDA) having the collection of media content items 117 stored in internal storage and connecting to the advertising server 105 over wireless connection 119. In such an embodiment, the collection of media content items 117 may be songs or other audio media content in MP3, WAV or other suitable audio file format. Alternatively, or additionally, the collection of media content items 117 may be images in JPEG, MPEG or other suitable file format.

In another embodiment, the delivery device 101 may be a set-top box and the media content storage device may be an internal or external digital video recorder (DVR). Such a DVR may store the collection of media content items 117 as video files, containing recorded broadcast transmissions or downloaded video content. In such an embodiment, the delivery device 101 may be coupled to the advertising server 105 via wired connection 119, such as a cable TV distribution system or a telephone system connection. The connection 119 may be over the Internet, or may be a direct point-to-point connection.

In yet another embodiment of the invention, the collection of advertisements 115 may be stored internally to the delivery device 101 and updated or changed occasionally by connection of the delivery device 101 to an external source of advertisements (not shown). Alternatively, the advertising server 105 may stream the individual advertisements in the collection of advertisements 115 into the delivery device 101 via the connection 119 over a direct broadcast satellite system.

Regardless of the format (audio, video, still picture) of the collection of media content items 117 stored in the storage device 107, the collection of advertisements 115 retrieved from the advertising server 105 and delivered to the user 103 may be of any format that can be rendered by the rendering device 113. The format of advertisement delivered by delivery system 100 may be different than the format of media content items stored in the storage device 107 without departing from the scope of the present invention.

Both the individual advertisements in the collection of advertisements 115 and the individual media content items in the collection of media content items 117 may be described according to characteristic properties (or characteristics). Examples of such characteristics include: content type, content style/genre, creator, performer, and creation data.

The content type of an advertisement or media content item may be its medium (video, still image, audio, etc.) or its file type (MPG, WMV, JPG, WAV, MP3, etc.). The characteristic of content type/genre may be a description of the content, such as holiday, landscape, jazz, horror, western, etc. The creator characteristic might indicate the producer or director of a movie or song, or the photographer of a still image. The performer characteristic might specify an actor or musician who is performing in a media content item or who is associated with the product or service being advertised. Examples of the creation data characteristic are: time of creation, place of creation, source of download, etc. Those skilled in the art will recognize that other descriptions of advertisements and media content items may be used as characteristics without departing from the scope of the invention.

Turning now to FIG. 2, a sequence of actions 200 for the advertising delivery system 100 to follow in selecting and delivering an advertisement from the collection of advertisements 115 is illustrated, according to one embodiment of the invention. In step 201, the delivery system 100 determines a value for each of a plurality of characteristics for some or all of the media content items in the collection of media content items 117. These values may be determined by the processor 109 or by the media content storage device 107. In step 203, values for a corresponding plurality of characteristics are determined for some or all of the advertisements in the collection of advertisements 115. This determination may be performed by the processor 109, the interface 111, or the advertising server 105.

The characteristics for which values are determined in steps 201 and 203 are chosen to correspond, so that in step 205 the determined values for the pluralities of advertisements and media content items may be compared meaningfully in order to select an advertisement for delivery to the user 103 of the delivery system 100. The selected advertisement is then delivered to the user 103 in step 207. Steps 205 and 207 may be performed by processor 109. Various techniques for comparing the values of the characteristics may be contemplated within the scope of the present invention.

Exemplary process 300 for the selection of an advertisement for delivery in step 205 is presented in FIG. 3. In step 301, measurements are made of the similarity of characteristic values between each advertisement considered in step 203 and each media content item considered in step 201. The degree of similarity may be expressed as a category; for example as strong, normal, or weak. Or the similarity may be expressed as a numeric value; for example, using the numbers 0 through 10. An advertisement to be delivered to the user 103 is then selected in step 303 according to these measured similarities between pairings of advertisements and media content items.

In one embodiment of the process 300, the similarity between an advertisement and a media content item may be computed individually for each of some or all of the characteristic values determined in steps 201 and 203, as shown in step 305. The computed individual characteristic similarities may then be combined, in step 307, to create the measure of the similarity between the advertisement and the media item.

Where the characteristic similarities are expressed numerically, the measure of similarity created in step 307 may be a simple arithmetic mean or may be a weighted average. Where the characteristic similarities are expressed categorically, the measure of similarity may be created by a fuzzy logic algorithm, as is well-known in the art. Other techniques for combining the computed individual characteristic similarities for an advertisement and a media content item will be recognized by one skilled in the art as falling within the scope of the present invention.

Whatever method is used to create the measure of similarity in step 307, the influence of individual characteristics on the combined measure may be varied by weighting their characteristic similarities prior to combining them. The weighting applied to each characteristic may be determined by a stored profile of the user 103. Alternatively or additionally, the weighting may be influenced by the context of the comparison. This contextual weighting may also be controlled by data in a stored user profile, with context attributes given greater or less weight according to stored values. Exemplary attributes of context are: the date or time of day at which the comparison is being made, the current weather, and the usage history of the advertisements or media content items. Other relevant context attributes will be apparent to one skilled in the art.

In step 303, the advertisement having the highest measured similarity to the highest number of media content items may be selected for delivery. In another embodiment of the invention, the similarity measurements for an advertisement across all media content items under consideration may be combined, in order to create a composite measure of the advertisement's similarity to the plurality of media content items considered in step 201. The advertisement with the highest composite measure of similarity may then be selected for delivery.

Alternatively, a predetermined minimum number or percentage of media content items may be chosen and all advertisements similar to at least that many items identified. One of that plurality of advertisements may then be selected for delivery in step 303. This selection may be made by random choice, by determining which of the plurality of advertisements has been least-recently delivered, or by some other technique familiar to those skilled in the art.

Turning now to FIG. 4, exemplary process 400 for selecting an advertisement for delivery in step 205 is presented. In step 401, for each of some or all of the characteristics considered in steps 201 and 203, the similarity of each advertisement to the media content items, taken as a group, may be measured. An advertisement may then be selected for delivery in step 403.

As described for step 303, in step 403 the advertisement having the greatest similarity for the greatest number of characteristics may be selected. Alternatively, each advertisement's similarity across some or all characteristics may be combined into a composite similarity and the advertisement with the greatest composite similarity selected. In another alternative, a plurality of advertisements meeting a similarity criterion may be identified and one of the plurality selected for delivery.

The measure of similarity formed in step 401 may be expressed categorically or numerically. To create the measure of similarity, each characteristic may be considered in turn and the similarity of the advertisement to each individual media content item computed for that characteristic, as indicated in step 405. In step 407, the computed individual characteristic similarities may then be combined to create the measure of the similarity of the advertisement to the media content items for that characteristic. As described for step 307, the individual characteristic similarities may be combined in step 407 arithmetically or by fuzzy logic or other techniques, and may be weighted according to stored user profile or the context of the comparison.

FIG. 5 illustrates an exemplary process 500 that may be performed before either of the processes 300 or 400 to reduce the number of comparisons needed to select an advertisement for delivery. One or more key characteristics for which the media content items show the greatest commonality may be identified. Then, in a process similar to process 300, shown in FIG. 3, the similarities between individual advertisements and individual media content items may be measured for only the key characteristics and an advertisement selected for delivery to the user 103. Alternatively, in a process similar to process 400, shown in FIG. 4, the similarities between individual advertisements and the media content items considered in step 201, taken as a group may be measured for only the key characteristics and an advertisement selected according to the measured similarities.

In step 501, the commonality of the media content items is measured for each characteristic. Like the similarity measures of steps 301 and 401, these commonality measures may be expressed categorically or numerically. The commonality measures for the characteristics may then be compared, in step 503, in order to select one or more key characteristics. The key characteristics selected may be those whose commonality measures exceed a predetermined threshold category or numerical value. The commonality measures for each characteristic may be weighted before comparison to the threshold. The weighting factors applied may be taken from a stored profile for the user 103.

Yet another exemplary process 600 for the selection of an advertisement for delivery in step 205 is presented in FIG. 6. In this process, a ‘virtual’ media content item, having characteristic values representative of the group of media content items is created. In a process similar to process 300, shown in FIG. 3, the advertisements may be compared to only the ‘virtual’ media content item in order to select an advertisement for delivery to the user 103. Such a process will require that each advertisement be compared to only a single media content item, rather than the plurality of media content items considered in step 301. As such, the process will require fewer comparisons to select an advertisement than process 300.

In step 601, a composite characteristic value may be determined for each characteristic, representing the value of that characteristic for all the media content items considered in step 201. The composite values may then be combined, in step 603 to create a ‘virtual’ media content item. Where the values of characteristics are expressed numerically, the composite characteristic value may be a simple arithmetic mean. Where the characteristic similarities are expressed categorically, the composite characteristic value may be created by a fuzzy logic algorithm, as is well-known in the art.

In step 605, the similarity of each advertisement to the ‘virtual’ media content item is then measured, in a way similar to that described for step 301. An advertisement may then be selected in step 607 by techniques similar to those described for step 303. In one embodiment of step 605, the similarity of an advertisement to the ‘virtual’ media content item may be computed in steps 609 and 611 in ways similar to those described for steps 305 and 307.

Although the present invention has been described in detail with respect to the illustrative example of a media content and advertising delivery system, those skilled in the art should understand that they can make various changes, substitutions and alterations herein without departing from the spirit and scope of the invention in its broadest form.

1. A device for delivering media content and advertising to a user (101), comprising:
a media content storage device (107), capable of storing a collection of media content items;
an interface (111), capable of connecting to an advertising server (105) storing a collection of advertisements;
a rendering device (113), capable of delivering said advertisements to said user; and
an advertisement selector (109) coupled to said media content storage device, said interface, and said rendering device, capable of:
determining values for a plurality of characteristics of a plurality of media content items in said collection of media content items,
determining values for a corresponding plurality of characteristics of a plurality of advertisements in said collection of advertisements, and
selecting a one of said plurality of advertisements for delivery to said user via said rendering device,
wherein said advertisement is selected according to a comparison between said determined characteristic values of said media content items and said determined characteristic values of said advertisements.

2. The device according to claim 1, wherein said advertisement selector is further capable of:
forming an advertisement-item similarity measure for each pairing of a one of said advertisements and a one of said media content items; and
selecting said one of said plurality of advertisements according to said advertisement-item similarity measures.

3. The device according to claim 2, wherein said advertisement selector is further capable of forming said advertisement-item similarity measure by
computing a characteristic similarity measure for each of said characteristics, representing a similarity between said value of said advertisement for said characteristic and said value of said media content item for said characteristic, and
combining said characteristic similarity measures to form said advertisement-item similarity measure.

4. The device according to claim 1, wherein said advertisement selector is further capable of:
forming an advertisement-characteristic similarity measure for each of said characteristics of each of said advertisements, representing a similarity between said advertisement and said media content items for said characteristic; and
selecting said one of said plurality of advertisements according to said advertisement-characteristic similarity measures.

5. The device according to claim 4, wherein said advertisement selector is further capable of forming said advertisement-characteristic similarity measure by
computing an item similarity measure for each of said media content items, representing a similarity between said value of said advertisement for said characteristic and said value of said media content item for said characteristic, and
combining said item similarity measures to form said advertisement-characteristic similarity measure.

6. The device according to claim 3, wherein said advertisement selector is further capable of:
computing a characteristic commonality measure for each of said characteristics, representing a similarity between said values of the media content items for said characteristic ;
selecting one or more key characteristics according to said characteristic commonality measures; and
computing said characteristic similarity measures for only said one or more key characteristics.

7. The device according to claim 1, wherein said advertisement selector is further capable of:
determining a composite characteristic value for each characteristic, representing said values of said media content items for said characteristic;
forming a characteristic similarity measure for each of said characteristics of each of said advertisements, representing a similarity between said value of said advertisement for said characteristic and said representative characteristic value for said characteristic; and
selecting said one of said plurality of advertisements according to said characteristic similarity measures.

8. The device according to claim 7, wherein said advertisement selector is further capable of:
forming a composite similarity measure for each of said advertisements by combining said characteristic similarity measures for said advertisement; and
selecting said one of said plurality of advertisements according to said composite similarity measures.

9. A system for delivering advertising to a user (100), comprising:
an advertising server (105) storing a collection of advertisements (115);
a media content storage device (107), capable of storing a collection of media content items (117); and
a media content and advertising delivery device (101) coupled to said advertising server and said media content storage device, comprising a rendering device (113), capable of delivering said advertisements to said user, and a processor (109) operative to
determine values for a plurality of characteristics of a plurality of media content items in said collection of media content items,
determine values for a corresponding plurality of characteristics of a plurality of advertisements in said collection of advertisements, and
deliver to said user via said rendering device a one of said plurality of advertisements according to a comparison between said characteristic values of said media content items and said characteristic values of said advertisements.

10. The system according to claim 9, wherein said processor is further operative to:
form an advertisement-item similarity measure for each pairing of a one of said advertisements and a one of said media content items; and
deliver said one of said plurality of advertisements according to said advertisement-item similarity measures.

11. The system according to claim 10, wherein said processor, in forming said advertisement-item similarity measures, is further operative to:
compute a characteristic similarity measure for each of said characteristics, representing a similarity between said value of said advertisement for said characteristic and said value of said media content item for said characteristic, and
combine said characteristic similarity measures to form said advertisement-item similarity measure.

12. The system according to claim 9, wherein said processor is further operative to:
form an advertisement-characteristic similarity measure for each of said characteristics of each of said advertisements, representing a similarity between said advertisement and said media content items for said characteristic; and
deliver said one of said plurality of advertisements according to said advertisement-characteristic similarity measures.

13. The system according to claim 12, wherein said processor, in forming said advertisement-characteristic similarity measures, is further operative to:
compute an item similarity measure for each of said media content items, representing a similarity between said value of said advertisement for said characteristic and said value of said media content item for said characteristic, and
combine said item similarity measures to form said advertisement-characteristic similarity measure.

14. The system according to claim 11, wherein said processor is further operative to:
compute a characteristic commonality measure for each of said characteristics, representing a similarity between said values of the media content items for said characteristic;
select one or more key characteristics according to said characteristic commonality measures; and
compute said characteristic similarity measures for only said one or more key characteristics.

15. The system according to claim 9, wherein said processor is further operative to:
determine a composite characteristic value for each characteristic, representing said values of said media content items for said characteristic;
form a characteristic similarity measure for each of said characteristics of each of said advertisements, representing a similarity between said value of said advertisement for said characteristic and said representative characteristic value for said characteristic; and
deliver said one of said plurality of advertisements according to said characteristic similarity measures.

16. The system according to claim 15, wherein said processor is further operative to:
form a composite similarity measure for each of said advertisements by combining said characteristic similarity measures for said advertisement; and
deliver said one of said plurality of advertisements according to said composite similarity measures.

17. For use in a media delivery device having access to a collection of media content items and a collection of advertisements, a method for delivering advertisements to a user, comprising the steps of:
determining values (201) for a plurality of characteristics of a plurality of media content items in the collection of media content items;
determining values (203) for a corresponding plurality of characteristics of a plurality of advertisements in the collection of advertisements; and
delivering to the user (207) a one of the plurality of advertisements according to a comparison (205) between the determined characteristic values of the media content items and the determined characteristic values of the advertisements.

18. The method of claim 17, wherein the step of delivering comprises the steps of:
forming an advertisement-item similarity measure for each pairing of a one of the advertisements and a one of the media content items; and
selecting for delivery a one of the advertisements according to the advertisement-item similarity measures.

19. The method of claim 18, wherein the step of forming an advertisement-item similarity measure comprises the steps of:
computing a characteristic similarity measure for each of the characteristics, representing a similarity between the value of the advertisement for the characteristic and the value of the media content item for the characteristic, and
combining the characteristic similarity measures to form the advertisement-item similarity measure.

20. The method of claim 17, wherein the step of delivering comprises the steps of:
forming an advertisement-characteristic similarity measure for each of the characteristics of each of the advertisements, representing a similarity between the advertisement and the media content items for the characteristic; and
selecting for delivery a one of the advertisements according to the advertisement-characteristic similarity measures.

21. The method of claim 20, wherein the step of forming an advertisement-characteristic similarity measure comprises the steps of:
computing an item similarity measure for each of the media content items, representing a similarity between the value of the advertisement for the characteristic and the value of the media content item for the characteristic, and
combining the item similarity measures to form the advertisement-characteristic similarity measure.

22. The method of claim 19, wherein the step of delivering further comprises:
computing a characteristic commonality measure for each of the characteristics, representing a similarity between the values of the media content items for the characteristic; and
selecting one or more key characteristics according to the characteristic commonality measures,
wherein the step of computing characteristic similarity measures computes similarity measures for only the one or more key characteristics.

23. The method of claim 17, wherein the step of delivering comprises:
determining a composite characteristic value for each of the characteristics, representing the values of the media content items for the characteristic;
forming a characteristic similarity measure for each of the characteristics of each of the advertisements, representing a similarity between the value of the advertisement for the characteristic and the representative characteristic value for the characteristic; and
selecting for delivery a one of the advertisements according to the characteristic similarity measures.

24. The method of claim 23, wherein the step of selecting comprises:
forming a composite similarity measure for each of the advertisements by combining the characteristic similarity measures for the advertisement; and
selecting the one of the advertisements according to the composite similarity measures.
